(19) United States
(12) Patent Application Publication
(10) Pub. No.: US 2026/0134372 A1
(43) Pub. Date: May 14, 2026

(54) SYSTEM AND METHOD FOR PREDICTION AND MITIGATION OF A RISK EVENT

(71) Applicant: DTM TECHNOLOGY, INC., Central Point, OR (US)

(72) Inventor: Todd M. Price, Central Point, OR (US)

(21) Appl. No.: 19/387,981

(22) Filed: Nov. 13, 2025

Related U.S. Application Data
(60) Provisional application No. 63/719,741, filed on Nov. 13, 2024.

(51) Int. Cl. G06Q 10/0635; G06Q 50/26; H04L 9/08

(52) U.S. Cl. CPC G06Q 10/0635; G06Q 50/265; H04L 9/0852

(57) ABSTRACT

A system for predicting and mitigating risk events is disclosed. The system includes data acquisition devices that collect first and second data sets associated with a geographical location and transmit them to a risk event mitigation server device. The risk event mitigation server device executes a dynamic threat mitigation module to generate weighted risk indicators, analyze their convergence and divergence, and compute a first risk score. A continuous automated red teaming module simulates risk events using artificial intelligence, while a machine learning adaptation module refines the score using real and simulated data to produce a second risk score. An orchestrator integrates outputs to generate mitigation recommendations, secured by a post-quantum encryption framework. A user device displays the updated risk score and recommendations and provides feedback. A recursive feedback loop continuously adjusts indicator weights based on user actions and new data, enabling adaptive, real-time risk assessment and mitigation.

### CROSS-REFERENCE TO RELATED APPLICATIONS

The present application claims priority under 35 U.S.C. § 119(e) to U.S. Provisional Patent Application No. 63/719741, titled “AI predictive modeling system for terrorism risk assessment,” filed November 13, 2024, the disclosure of which is herein incorporated by reference in its entirety.

### BACKGROUND OF THE INVENTION

Ensuring public safety and security amid global uncertainty remains an ongoing and vital challenge, given the constant threat of coordinated malicious activity. These threats include, but are not limited to, terrorism, cyberattacks, organized crime, and other events that could harm individuals, infrastructure, or societal functions. Conventional methods for predicting and assessing risk events often depend solely on immediate or real-time intelligence, without examining the underlying causes of these events, which limits the effectiveness of prediction and deterrence.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an exemplary environment including a system for predicting and mitigating a risk event, in accordance with some embodiments;

FIG. 2 illustrates a block diagram of a risk event mitigation server device included in the exemplary system of FIG. 1, in accordance with some embodiments;

FIG. 3 illustrates a block diagram of a risk event mitigation server memory of the risk event mitigation server device of FIG. 2, in accordance with some embodiments;

FIG. 4 illustrates a block diagram of a user device included in the exemplary system of FIG. 1, in accordance with some embodiments;

FIG. 5 illustrates an exemplary flow of data in the system of FIG. 1, in accordance with some embodiments; and

FIG. 6 illustrates an exemplary flowchart of a method for predicting and mitigating the risk event at a geographical location, in accordance with some embodiments.

Skilled artisans will appreciate that the elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In one aspect, a system for predicting and mitigating a risk event is disclosed. The system for predicting and mitigating a risk event includes a plurality of data acquisition devices configured to collect a first data set and a second data set associated with a geographical location. The system further includes a network interface communicatively coupled with the plurality of data acquisition devices and configured to transmit the first data set and the second data set. The system further includes a risk event mitigation server device comprising one or more risk event mitigation processors in communication with the network interface and one or more risk event mitigation server memories storing instructions that, when executed by the one or more risk event mitigation processors, cause the risk event mitigation server device to execute these instructions. The risk event mitigation server device further executes a dynamic threat mitigation module to receive the first data set from the network interface, generate the plurality of risk indicators from the first data set, assign a plurality of weighted coefficients to the plurality of risk indicators, analyze a convergence of the plurality of risk indicators, analyze a divergence of the plurality of risk indicators; and compute a first risk score. The first risk score incorporates the plurality of weighted coefficients to the plurality of risk indicators and their convergent and divergent interactions. The risk event mitigation server device further executes a continuous automated red teaming module configured to employ an artificial-intelligence model to simulate a risk event using the first data set and the second data set, and provide a simulated risk event data set. A machine learning adaptation module, when executed by the risk event mitigation server device, is further configured to refine the first risk score using the second data set and the simulated risk event data set to generate a second risk score. The risk event mitigation server device further executes an orchestrator module configured to control communication between and combine the output of the dynamic threat mitigation module, the continuous automated red teaming module, and the machine learning adaptation module to determine a set of risk event mitigation recommendations for the geographical location. The risk event mitigation server device further executes a post-quantum encryption service module configured to provide a quantum-resistant encryption framework to secure the communication between the dynamic threat mitigation module, the machine learning adaptation module, and the continuous automated red teaming module. The system further includes a user device communicatively coupled to the risk event mitigation server device via the network interface and configured to display, via a user device display, the second risk score and the set of risk event mitigation recommendations for the geographical location, and provide a qualified action. The risk event mitigation server device further implements a recursive feedback loop configured to continuously adjust the weighted coefficients of the plurality of risk indicators in the dynamic threat mitigation module based on the qualified action and the second data set, continuously updating the second risk score and the risk event mitigation recommendations in real-time.

In another aspect, a method for predicting and mitigating a risk event at a geographical location is disclosed. The method includes collecting a first data set and a second data set associated with the geographical location using a plurality of data acquisition devices, transmitting the first data set and the second data set to a risk event mitigation server device via a network interface, and receiving, by a dynamic threat mitigation module of the risk event mitigation server device, the first data set. Further, the method includes generating, by the dynamic threat mitigation module, the plurality of risk indicators from the first data set, assigning, by the dynamic threat mitigation module, a plurality of weighted coefficients to the plurality of risk indicators, analyzing, by the dynamic threat mitigation module, a convergence of the plurality of risk indicators, analyzing, by the dynamic threat mitigation module, a divergence of the plurality of risk indicators, and computing, by the dynamic threat mitigation module, a first risk score, wherein the first risk score incorporates the plurality of weighted coefficients to the plurality of risk indicators and their convergent and divergent interactions. The method further includes simulating, by a continuous automated red teaming module of the risk event mitigation server device, a risk event using the first data set and the second data set to provide a simulated risk event data set, refining, by a machine learning adaptation engine of the server device, the first risk score using the second data set and the simulated risk event data set to generate a second risk score, and controlling, by an orchestrator module of the risk event mitigation server device, communication between and combining the output of the dynamic threat mitigation module, the continuous automated red teaming module, and the machine learning adaptation engine to determine a set of risk event mitigation recommendations for the geographical location. Further, the method includes displaying, via a user device, the second risk score and the set of risk event mitigation recommendations for the geographical location and providing, via the user device, a qualified action. The method further includes implementing, by the risk event mitigation server device, a recursive feedback loop to continuously adjust the plurality of weighted coefficients of the plurality of risk indicators in the dynamic threat mitigation module based on the qualified action and the second data set and continuously updating the second risk score and the risk event mitigation recommendations in real-time.

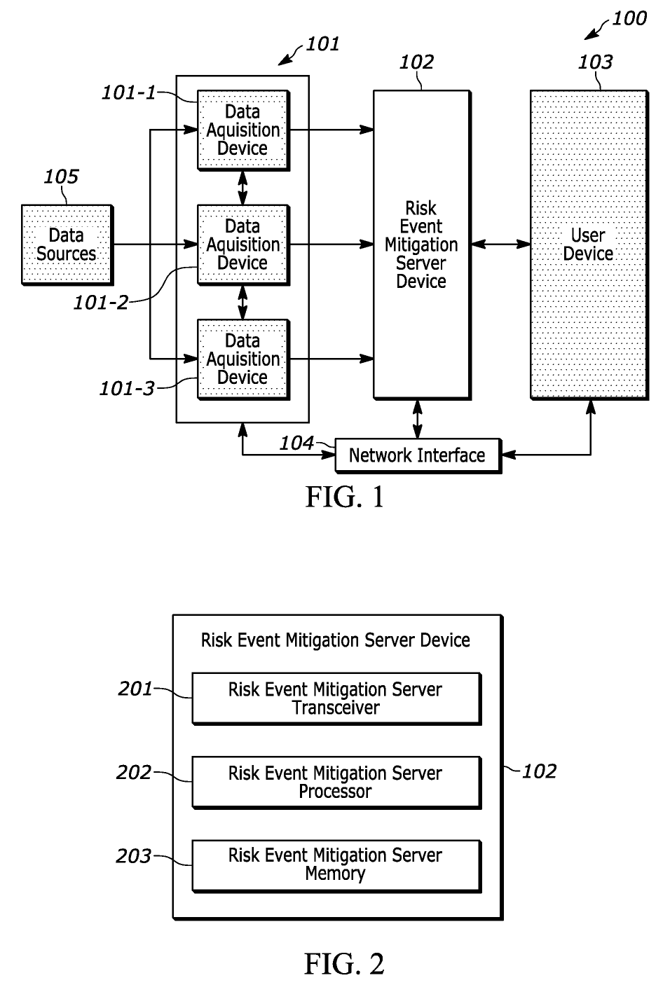

FIG. 1 illustrates an environment including a system 100 for predicting and mitigating a risk event in accordance with various embodiments. As used herein, the term “risk event” refers to an incident, occurrence, or condition that poses or has the potential to pose a threat to public safety, national security, critical infrastructure, economic stability, or societal functioning. The risk event comprises one or more from a group comprising terrorist attacks on public spaces or critical infrastructure, cyberattacks that disrupt essential services or compromise sensitive data, organized crime activities such as trafficking or sabotage that threaten societal stability, deliberate attacks on transportation networks, utilities, or supply chains, contamination of food or water supplies, mass protests escalating into violence, and emerging hybrid threats like disinformation campaigns, drone-enabled attacks or other such events now known or in the future occurring. In accordance with various embodiments, the system 100 is configured to predict and mitigate such risk events at a geographical location. The geographical location pertains to an area of interest to a user without any limitations, including no restrictions on the number of locations the user is interested in predicting one or more risk events. For example, the geographical location corresponds to a specific position of a place, including but not limited to a country, city, region, a school, a hospital, an airport, or a shopping mall, or any area on the Earth's surface. The geographical location is described in terms of absolute location, using precise coordinates such as latitude and longitude, or in relative terms, based on its position in relation to other places, including neighboring countries, rivers, landmarks, and any other similar relative position now known or in the future determined. In accordance with various embodiments, the system 100 for predicting and mitigating the risk event is designed to predict the risk event across multiple geographic locations simultaneously.

The system 100 includes a plurality of data acquisition devices 101, a risk event mitigation server device 102, and a user device 103 in communication with each other via a network interface 104. The network interface 104 enables the plurality of data acquisition devices 101, the risk event mitigation server device 102, and the user device 103 to communicate over a network (not shown). Although not shown, a person skilled in the art would appreciate that the network includes, but not limited to, a Local Area Network (LAN), a Wireless Local Area Network (WLAN), a Small Area Network (SAN), a Wi-Fi Direct Network, a telecommunication network including, but not limited to, a fourth generation (4G) and a fifth generation (5G) cellular network, and any communication network for data communication presently known or in future developed.

Each data acquisition device 101 of the plurality of data acquisition devices 101, such as, data acquisition devices 101-1, 101-2, 101-3 is configured to collect and transmit data associated with the geographical location. For example, each data acquisition device 101 is configured to collect a first data set and a second data set associated with the geographical location, as described in detail in the forthcoming disclosure. As used herein, the term “data acquisition device” refers to any hardware, software, or hybrid component configured to collect, capture, sense, obtain, record, or transmit data associated with a geographical location. The data acquisition device 101 is either an automated device or a manual device. An automated data acquisition device refers to a device that is configured to autonomously collect, process, and transmit data without requiring human intervention. A manual data acquisition device refers to a device or tool operated or supervised by a human user for collecting, recording, or inputting data, typically used where human judgment or verification is required. For example, the data acquisition device 101 includes one or more of a sensor, a global positioning system device, a motion detector, an environmental sensor, a Global Positioning System (GPS) enabled mobile device, a surveillance camera, an acoustic sensor, a remote sensing device, a drone, a satellite, a light detection and ranging device, and similar devices configured to capture data associated with a geographical location, now known or developed in future. In some embodiments, the data acquisition device 101 is configured to access or interface with one or more data sources 105, via the network interface 104, to obtain the first data set and/or the second data set associated with the geographical location. The data sources 105 include, but are not limited to, government and municipal databases, law enforcement and intelligence agency repositories, transportation and logistics databases, meteorological and environmental databases, financial transaction records, public health databases, open-source intelligence (OSINT) repositories, or any such source for obtaining the first data set and/or the second data set.

The plurality of data acquisition devices 101 are installed at the geographical location in a manner that ensures comprehensive coverage of the desired area of interest. Each data acquisition device 101 is positioned, calibrated, or configured to monitor a defined coverage zone within the geographical location, such that the collective deployment of the plurality of data acquisition devices 101 forms an integrated sensing network encompassing the entire area. The coverage area of each data acquisition device 101 varies depending on its type, sensing capability, and intended application. In one example, the data acquisition device 101 comprises a plurality of surveillance cameras strategically installed across the geographical location, such as at public entrances, corridors, perimeters of critical facilities, or along transportation routes. Each surveillance camera is configured to monitor a defined field of view based on its orientation, elevation, and lens specification, thereby capturing visual data within its designated coverage zone. The cameras are mounted on poles, building exteriors, or overhead structures to achieve optimal visibility and minimize obstruction. The plurality of surveillance cameras are configured to operate in coordination, such that overlapping fields of view ensure complete visual coverage of the area of interest and provide redundancy for continuous monitoring.

In another example, the data acquisition device 101 comprises a network of motion or proximity sensors installed throughout the geographical location to detect human activity, vehicular movement, or unusual physical disturbances. Each sensor is configured to monitor a specific detection radius and is positioned at critical nodes such as facility entrances, corridors, parking areas, or perimeter boundaries. The sensors are installed on walls, ceilings, or embedded within ground surfaces, depending on the operational requirement and site topology. The plurality of motion or proximity sensors are configured to communicate through the network interface 104 to provide real-time event detection data, enabling the system 100 to identify and assess potential anomalies or emerging risk indicators across the monitored area.

As shown in FIG. 1, the plurality of data acquisition devices 101 at the geographical location are configured to communicate with each other through the network, enabling coordinated data collection. For example, when a motion sensor detects movement within its coverage area, it transmits a trigger signal to one or more nearby surveillance cameras through the network interface 104. In response, the corresponding cameras automatically adjust their focus, activate recording, or switch to high-resolution mode to capture visual evidence of the detected activity. Conversely, when a surveillance camera identifies an anomaly or pattern of interest, it signals the surrounding sensors to increase their sampling rate or expand their detection sensitivity.

The first data set includes one or more data sets from a group comprising a historical data set, a socioeconomic data set, an educational data set, and an intelligence data set associated with the geographical location. As used herein, the term “historical data set” refers to archived or time-series data capturing records of past events, activities, or conditions within the geographical location. Such data provide a temporal context that allows the system 100 to analyze patterns, trends, and periodicity of prior incidents relevant to risk assessment. The historical data set includes, but is not limited to, data relating to past terrorist incidents, civil unrest, cyberattacks, crime rates, emergency response logs, weather anomalies, or infrastructure failures recorded over defined intervals. For example, a historical data set for a metropolitan area includes records of protest frequency over the past five years, patterns of network outages correlated with previous cyberattacks, or historical temperature, and pollution variations. As used herein, the term “socioeconomic data set” refers to data describing the demographic, economic, and social attributes of the population within the geographical location. The data includes metrics such as population density, age distribution, income levels, employment or unemployment rates, healthcare access, public service distribution, or urban development indices. For example, a socioeconomic data set for a coastal city includes household income data, job loss rates during economic downturns, and the density of residential settlements near industrial zones. As used herein, the term “educational data set” refers to data representing the education level, literacy rate, institutional distribution, and academic population within the geographical location. The data includes the number and type of educational institutions, enrollment figures, literacy statistics, research activity indices, and public or private education participation rates. Such data contribute to understanding the societal and behavioral dynamics of the monitored region. For example, an educational data set for a university district includes student population figures, density of campuses, and past records of student demonstrations or campus security incidents. As used herein, the term “intelligence data set” refers to data collected from government agencies, defense departments, law enforcement bodies, verified open-source intelligence (OSINT) platforms or other such data sources 105. The intelligence data set provides actionable insights regarding ongoing or potential threats to the geographical location, including details of organized crime, extremist activities, geopolitical developments, or digital intrusion attempts. For example, an intelligence data set for a border region includes threat bulletins from national security agencies, intercepted communications of known criminal organizations, or satellite imagery of suspicious movements near sensitive infrastructure.

The second data set includes one or more data sets from a group comprising a real-time intelligence data set, a real-time news data set, a real-time political data set, and a real-time social media data set associated with the geographical location. The term “real-time,” as used herein, refers to the substantially instantaneous acquisition, transmission, and processing of data such that actionable information is available with minimal latency relative to the occurrence of the monitored event. As used herein, the term “real-time intelligence data set” refers to continuously updated intelligence information received from official, commercial, or open-source channels that provides near-instantaneous insight into emerging threats or security anomalies. For example, a real-time intelligence data set includes alerts from a national security monitoring system reporting unusual cross-border activity, or live updates from a cybersecurity threat feed identifying coordinated phishing or malware attacks targeting critical infrastructure. As used herein, the term “real-time news data set” refers to continuously updated data derived from electronic news sources, online publications, broadcast feeds, or verified press agencies that report ongoing events relevant to the geographical location. For example, a real-time news data set includes live feeds or newswire updates reporting the sudden closure of transportation hubs, ongoing civil demonstrations, or emergency alerts. As used herein, the term “real-time political data set” refers to data representing ongoing political developments, decisions, or sentiments that influence public stability or risk conditions within the geographical location. For example, a real-time political data set includes the live broadcast of a government declaration imposing emergency regulations, results of a national referendum, or political rally updates that could trigger mass gatherings. As used herein, the term “real-time social media data set” refers to dynamic, user-generated content gathered from online social networking platforms, microblogging sites, or community forums. This data set reflects collective sentiment, behavioral trends, and spontaneous event reports from individuals located within or near the geographical location. For example, a real-time social media data set includes trending posts or hashtags indicating mass protests forming in a city center, viral content suggesting panic buying, or geotagged posts reporting an explosion or disturbance.

The plurality of data acquisition devices 101, for example, 101-1, 101-2, 101-3, are configured to perform real-time data collection of the second data set. For example, a surveillance camera installed at a transportation hub acts as a data acquisition device 101 configured to capture live video feeds of human and vehicular movement. The data collected by the surveillance camera corresponds to a real-time intelligence data set, which is used to detect unusual gatherings, crowd density fluctuations, or suspicious activities indicative of a potential risk event. In another example, an environmental sensor installed near an industrial facility operates as a data acquisition device 101 configured to monitor air quality, temperature, or radiation levels. The information captured by this device over a period of time corresponds to a historical data set and the information captured in real time corresponds to a real-time news data set, allowing the system 100 to compare current measurements with past environmental records and to identify contamination or hazardous conditions. In a further example, a Global Positioning System (“GPS”)-enabled mobile device deployed with a field personnel functions as a data acquisition device 101 configured to record geolocation, movement patterns, and on-ground observations. The data obtained from such a device over a period of time forms a socioeconomic data set and a real-time data corresponds to a real-time social media data set, capturing both positional intelligence and behavioral indicators relevant to human activity within the monitored region. In yet another example, a drone or satellite imaging system serves as a data acquisition device 101 that captures geospatial imagery and terrain data of the geographical location. The corresponding data captured over a period of time forms a historical data set and a real-time data corresponds to a real-time political or intelligence data set, which is analyzed to detect unauthorized construction, crowd formations, or infrastructure damage linked to potential risk events.

The risk event mitigation server device 102 functions as the central processing and analytical component of the system 100. The risk event mitigation server device 102 is configured to receive the first and second data sets from the plurality of data acquisition devices 101, aggregate and normalize the received data, and execute stored modules to generate risk scores and corresponding mitigation recommendations, which are securely transmitted to the user device 103 in real time. The risk scores are configured to forecast a likelihood of occurrence of the risk event at the geographical location.

The network interface 104 facilitates seamless, bi-directional communication between the plurality of data acquisition devices 101, the risk event mitigation server device 102, the data sources 105, and the user device 103. The network interface 104 is configured to manage the transmission of data with high throughput and low latency, using secure communication protocols. The network interface 104 ensures uninterrupted connectivity, coordinated data exchange, and integrity of transmitted information across wired, wireless, or hybrid networks described above. For example, the network interface 104 enables real-time video feeds from surveillance cameras and telemetry data from motion sensors at an airport to be transmitted simultaneously to the risk event mitigation server device 102 over the network.

The user device 103 provides the interactive interface through which authorized users access, view, and respond to outputs of the risk event mitigation server device 102. The user device 103 is configured to display real-time risk scores, alerts, and mitigation recommendations received from the risk event mitigation server device 102 via the network interface 104, allowing users to monitor multiple geographical locations simultaneously. The user device 103 further enables users to input feedback or actions (hereinafter interchangeably referred to as qualified action). In some embodiments (not shown), the system 100 includes a plurality of user devices 103 operated by multiple users located at different geographic locations, each configured to access and interact with the risk event mitigation server device 102 through respective network connections.

The various components of the risk event mitigation server device 102 (interchangeably referred to as a server) for facilitating the prediction of the risk event and providing mitigation recommendations will now be described with reference to FIG. 2. It should be appreciated by those of ordinary skill in the art that FIG. 2 depicts the risk event mitigation server device 102 in a simplified manner, and a practical embodiment configured to include additional components and suitably configured logic to support known or conventional operating features that are not described in detail herein. It will further be appreciated by those of ordinary skill in the art that the risk event mitigation server device 102 is configured to be a personal computer, desktop computer, tablet, smartphone, or any other computing device now known or developed in the future. The risk event mitigation server device 102 includes a plurality of electrical and electronic components, providing power, operational control, communication, and the like within the risk event mitigation server device 102. For example, the risk event mitigation server device 102 includes, among other things, a risk event mitigation server transceiver 201, a risk event mitigation server processor 202, and a risk event mitigation server memory 203.

Further, although the risk event mitigation server device 102 is shown and described to be implemented within a single computing device, the one or more components of the risk event mitigation server device 102 are configured to alternatively be implemented in a distributed computing environment, without deviating from the scope of the claimed subject matter. It will further be appreciated by those of ordinary skill in the art that the risk event mitigation server device 102 is alternatively configured to function within a remote server device, cloud computing device, or any other remote computing mechanism now known or developed in the future. For example, the risk event mitigation server device 102 in some embodiments is configured to be a cloud environment incorporating the operations of the risk event mitigation server transceiver 201, the risk event mitigation server processor 202, and the risk event mitigation server memory 203, and various other operating modules to serve as a software-as-a-service model for the user device 103.

The components of the risk event mitigation server device 102, including the risk event mitigation server transceiver 201, the risk event mitigation server processor 202, and the risk event mitigation server memory 203, are configured to communicate with one another via a risk event mitigation server local interface (not shown). The risk event mitigation server local interface is configured to be, for example, but not limited to, one or more buses or other wired or wireless connections, as is known in the art. The risk event mitigation server local interface is configured to have additional elements, but not limited to, such as controllers, buffers (caches), drivers, repeaters, and receivers, among many others, to enable communications. Further, the risk event mitigation server local interface includes address, control, and/or data connections to enable appropriate communications among the aforementioned components.

The risk event mitigation server transceiver 201 includes a transmitter circuitry and a receiver circuitry (not shown) to enable the risk event mitigation server device 102 to communicate data to and acquire data from other devices, such as, the plurality of data acquisition devices 101 and the user device 103 via the network interface 104. In this regard, the transmitter circuitry is configured to include appropriate circuitry to transmit the data to the other devices, such as, the user device 103. Similarly, the receiver circuitry is configured to include appropriate circuitry to receive data from the other devices, such as, but not limited to, from the plurality of data acquisition devices 101 and the user device 103. In some embodiments, the receiver circuitry, in conjunction with communication control logic is configured to receive network messages from the user device 103 that include user feedback data related to the risk event.

The transmitter circuitry and the receiver circuitry together form a wireless transceiver to enable wireless communication with the user device 103 and the plurality of data acquisition devices 101 via the network interface 104. It will be appreciated by those of ordinary skill in the art that the risk event mitigation server device 102 is configured to include a single risk event mitigation server transceiver 201 as shown, or alternatively separate transmitting and receiving components, for example, but not limited to, a transmitter, a transmitting antenna, a receiver, and a receiving antenna.

The risk event mitigation server memory 203 is a non-transitory memory configured to store a set of instructions that are executable by the risk event mitigation server processor 202 to perform the predetermined operations. For example, the risk event mitigation server memory 203 is configured to include any of the volatile memory elements (for example, random access memory (RAM), nonvolatile memory elements (for example read only memory (ROM)), and combinations thereof. Moreover, the risk event mitigation server memory 203 is configured to incorporate electronic, magnetic, optical, and/or other types of storage media.

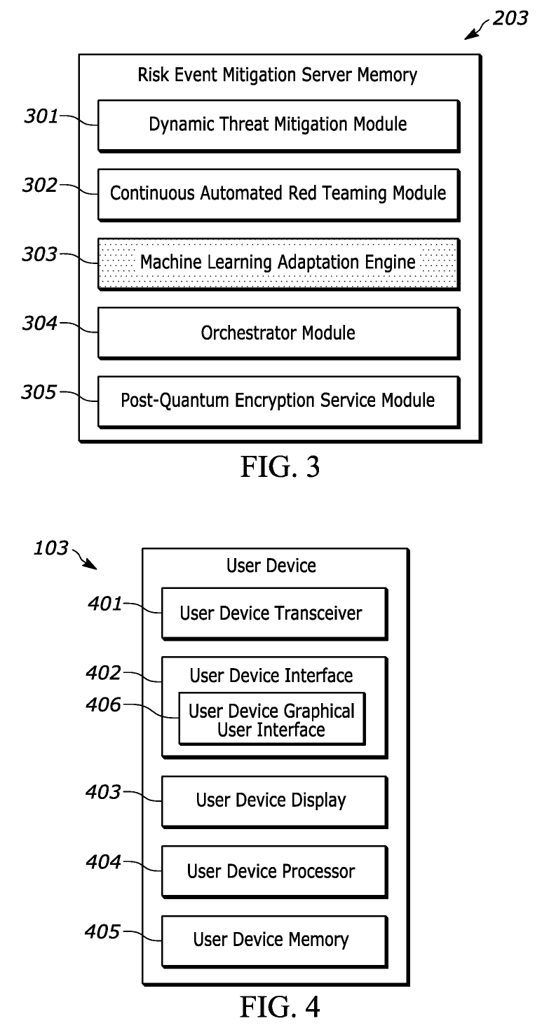

As shown in FIG. 3, the risk event mitigation server memory 203 is configured to store a dynamic threat mitigation module 301, a continuous automated red teaming module 302, a machine learning adaptation module 303, an orchestrator module 304, and a post-quantum encryption service module 305. The risk event mitigation server processor 202 retrieves and executes the instructions stored in the risk event mitigation server memory 203 such that the risk event mitigation server processor 202 performs the functional operations of each of the dynamic threat mitigation module 301, the continuous automated red teaming module 302, the machine learning adaptation module 303, the orchestrator module 304, and the post-quantum encryption service module 305. Accordingly, while the dynamic threat mitigation module 301, the continuous automated red teaming module 302, the machine learning adaptation module 303, the orchestrator module 304, and the post-quantum encryption service module 305 are maintained in the risk event mitigation server memory 203, the computational processing is carried out by the risk event mitigation server processor 202 executing the stored instructions. In accordance with various embodiments, the dynamic threat mitigation module 301, the continuous automated red teaming module 302, the machine learning adaptation module 303, the orchestrator module 304, and the post-quantum encryption service module 305 are configured to communicate with one another through one or more inter-module communication mechanisms (not shown). Such communication is configured to be implemented via direct memory access, message-passing interfaces, shared data structures, or through an internal service bus or framework. The communication is configured to be synchronous or asynchronous, depending on the operational requirements of the risk event mitigation server memory 203. In synchronous communication, the dynamic threat mitigation module 301, the continuous automated red teaming module 302, the machine learning adaptation module 303, the orchestrator module 304, and the post-quantum encryption service module 305 are configured to transmit a request and await a corresponding response or acknowledgment prior to proceeding with subsequent processing. In asynchronous communication, the dynamic threat mitigation module 301, the continuous automated red teaming module 302, the machine learning adaptation module 303, the orchestrator module 304, and the post-quantum encryption service module 305 are configured to exchange messages, events, or notifications through a non-blocking protocol, allowing concurrent operations. The communication is configured to further support standardized data exchange formats, such as structured data objects, serialized message formats, or encrypted communication channels, thereby maintaining consistency and security across the interactions. The risk event mitigation memory 203 is configured to further employ access control policies or authentication mechanisms to govern communication privileges among the dynamic threat mitigation module 301, the continuous automated red teaming module 302, the machine learning adaptation module 303, the orchestrator module 304, and the post-quantum encryption service module 305, ensuring that only authorized components are configured to initiate or respond to specific operational commands or data exchanges.

In accordance with various embodiments, the dynamic threat mitigation module 301, the continuous automated red teaming module 302, and the machine learning adaptation module 303, when executed by the risk event mitigation server processor 202, are configured to communicate with the plurality of data acquisition devices 101 to receive the first data set and the second data set. The orchestrator module 304 is configured to control communication between and combine the outputs of the dynamic threat mitigation module 301, the continuous automated red teaming module 302, and the machine learning adaptation module 303 to receive a set of risk event mitigation recommendations for the geographical location and communicate the recommendations to one or more user devices 103. The post-quantum encryption service module 305 is configured to provide a quantum-resistant encryption framework to secure the communication between the dynamic threat mitigation module 301, the machine learning adaptation module 303, the continuous automated red teaming module 302, and the orchestrator module 304. For example, when the machine learning adaptation module 303 sends data to the orchestrator module 304, the post-quantum encryption service module 305 automatically encrypts the data using quantum-resistant algorithms to prevent any unauthorized access. Similarly, when the orchestrator module 304 shares data with the one or more user devices 103, the post-quantum encryption service module 305 ensures that the information remains secure and cannot be decoded even by advanced computing systems, thereby protecting sensitive intelligence and maintaining data integrity across the system 100.

Referring back to FIG. 2, the risk event mitigation server processor 202 is configured to execute the instructions stored in the risk event mitigation server memory 203 to perform the predetermined operations, for example the detailed functions of the risk event mitigation server device 102 as will be described hereinafter. The risk event mitigation server processor 202 is configured to include one or more microprocessors, microcontrollers, DSPs (digital signal processors), state machines, logic circuitry, or any other device or devices that process information or signals based on operational or programming instructions. The risk event mitigation server processor 202 is configured to be implemented using one or more controller technologies, such as Application Specific Integrated Circuit (ASIC), Reduced Instruction Set Computing (RISC) technology, Complex Instruction Set Computing (CISC) technology or any other similar technology now known or in the future developed. The risk event mitigation server processor 202 is configured to cooperate with other components of the risk event mitigation server device 102 to perform operations pursuant to generating risk scores and corresponding mitigation recommendations.

The various components of the user device 103 will now be described with reference to FIG. 4. It should be appreciated by those of ordinary skill in the art that FIG. 4 depicts the user device 103 in a simplified manner, and a practical embodiment includes additional components and suitably configured logic to support known or conventional operating features that are not described in detail herein. It will further be appreciated by those of ordinary skill in the art that the user device 103 is configured to include one or more of a personal computer, desktop computer, tablet, smartphone, augmented reality device, mixed reality device, or any other computing device now known or developed in the future. Further, although the user device 103 is shown and described to be implemented within a single computing device, the one or more components of the user device 103 is configured to alternatively be implemented in a distributed computing environment, without deviating from the scope of the claimed subject matter. It will further be appreciated by those of ordinary skill in the art that the user device 103 alternatively permits function within a remote server, cloud computing device, or any other local or remote computing mechanism now known or developed in the future. Each user device 103 includes a plurality of electrical and electronic components, providing power, operational control, communication, and the like within the user device 103.

The user device 103 includes, among other components, a user device transceiver 401, a user device interface 402, a user device display 403, a user device processor 404, and a user device memory 405. The components of the user device 103, including the user device transceiver 401, the user device interface 402, the user device display 403, the user device processor 404, and the user device memory 405, are configured to cooperate with one another to enable operations of the user device 103. Each component is permitted to communicate with one another via a user device local interface (not shown). The user device local interface includes, for example, but not limited to, one or more buses or other wired or wireless connections, as is known in the art. The user device local interface has additional elements, which are omitted for simplicity, such as controllers, buffers (caches), drivers, repeaters, and receivers, among many others, to enable communications. Further, the user device local interface includes address, control, and/or data connections to enable appropriate communications among the aforementioned components.

As illustrated, the user device 103 in the exemplary embodiment includes the user device transceiver 401 to provide one or more inputs to and receive one or more outputs from one or more devices, such as, the risk event mitigation server device 102. The user device transceiver 401 includes a transmitter circuitry and a receiver circuitry to enable the user device 103 to communicate data to and acquire data from the other devices. In this regard, the transmitter circuitry includes appropriate circuitry to transmit one or more outputs, such as, but not limited to, data associated with the risk event, to the risk event mitigation server device 102. Similarly, the receiver circuitry includes appropriate circuitry to receive one or more inputs, such as, but not limited to, notification(s) associated with the prediction of the risk event from the risk event mitigation server device 102. It will be appreciated by those of ordinary skill in the art that the user device 103 is permitted to include a single user device transceiver 401 as shown, or alternatively separate transmitting and receiving components, for example, but not limited to, a transmitter, a transmitting antenna, a receiver, and a receiving antenna.

The user device interface 402 is configured to receive input from and/or to provide system output to the user. Input is permitted to be provided via, for example, a keyboard, a touch screen display (such as the user device display 403), a camera, a touch pad, a microphone, a recorder, a sensor, and/or a mouse or any other user input mechanism now known or developed in the future. System output is permitted to be provided via a display device, such as the user device display 403, a speaker, a haptic output, or any other output mechanism now known or developed in the future. The user device interface 402 is permitted to further include, for example, a serial port, a parallel port, an infrared (IR) interface, a universal serial bus (USB) interface and/or any other interface herein known or developed in the future.

In some embodiments, the user device interface 402 includes a user device graphical user interface 406 through which the user communicates to and from the risk event mitigation server device 102. The user device graphical user interface 406 is configured to display the second risk score and the risk event mitigation recommendation and provide the feedback to the risk event mitigation server device 102 for updating the risk event prediction. The user device graphical user interface 406 includes one or more of graphical elements associated with receiving the user feedback and displaying the second risk score and the risk event mitigation recommendation received from the risk event mitigation server device 102. The graphical elements include, but are not limited to one or more of graphical icons, control buttons, selection boxes, progress indicators, pull-down menus, on-off checkmarks, scroll bars, windows, window edges, toggle buttons, and/or forms. The graphical elements are configured to be used in conjunction with text to prompt the user for an input, respond to user actions, or display information to the user in response to the one or more instructions from the risk event mitigation server device 102. The user device display 403 is configured to display the second risk score and the risk event mitigation recommendation in the form of data, images, videos, and the like. The user device display 403 includes, for example, any display screen or a computer monitor now known or developed in the future.

The user device memory 405 is a non-transitory memory configured to store a set of instructions that are executable by the user device processor 404 to perform predetermined operations. For example, the user device memory 405 is configured to include any of the volatile memory elements (for example, random access memory (RAM), nonvolatile memory elements (for example, read-only memory (ROM)), and combinations thereof. Moreover, the user device memory 405 is configured to incorporate electronic, magnetic, optical, and/or other types of storage media. In some embodiments, the user device memory 405 is also configured to store data, such as, but not limited to, the risk event prediction score and recommendations.

The user device processor 404 is configured to execute the instructions stored in the user device memory 405 to perform the predetermined operations, for example the detailed functions of the user device 103 as will be described hereinafter. The user device processor 404 is configured to include one or more microprocessors, microcontrollers, DSPs (digital signal processors), state machines, logic circuitry, or any other device or devices that process information or signals based on operational or programming instructions. The user device processor 404 is configured to be implemented using one or more controller technologies, such as Application Specific Integrated Circuit (ASIC), Reduced Instruction Set Computing (RISC) technology, Complex Instruction Set Computing (CISC) technology or any other similar technology now known or in the future developed. The user device processor 404 is configured to cooperate with other components of the user device 103 to perform operations pursuant to communications and one or more instructions from the risk event mitigation server device 102.

In accordance with various embodiments, the user device 103 is configured to receive, via the user device transceiver 401, the notification(s) associated with the risk event associated with the geographical location from the risk event mitigation server device 102 and display the received notification(s) on the user device graphical user interface 406. The user device 103 is further configured to enable a user to select or provide the qualified action to update the risk event prediction and mitigation recommendations via the user device interface 406 and transmit, via the user device transceiver 401, one or more qualified actions to the risk event mitigation server device 102.

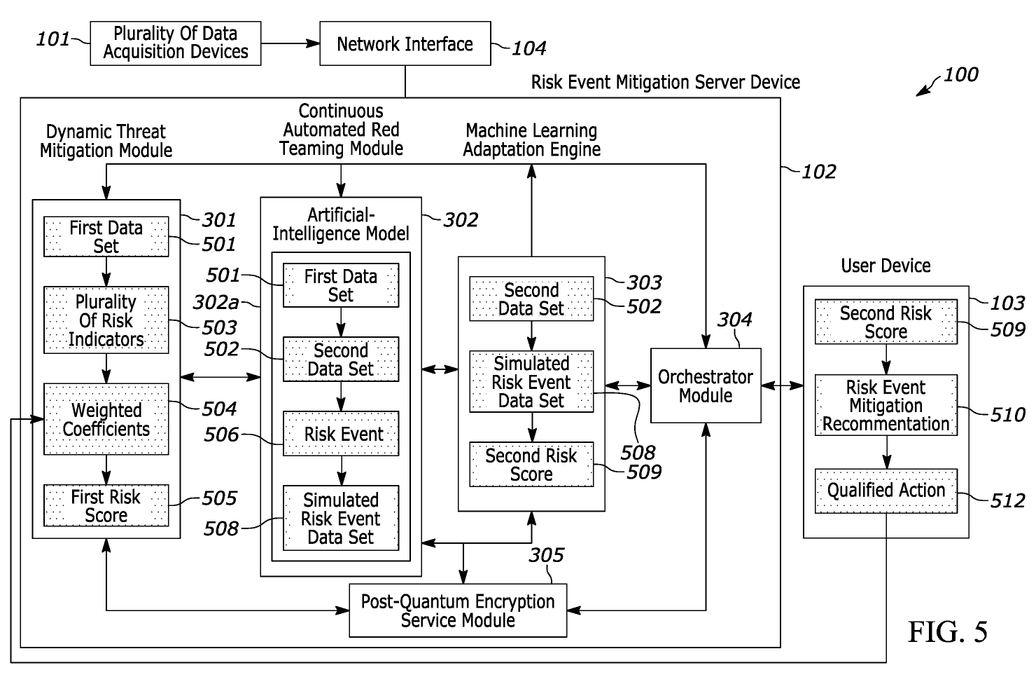

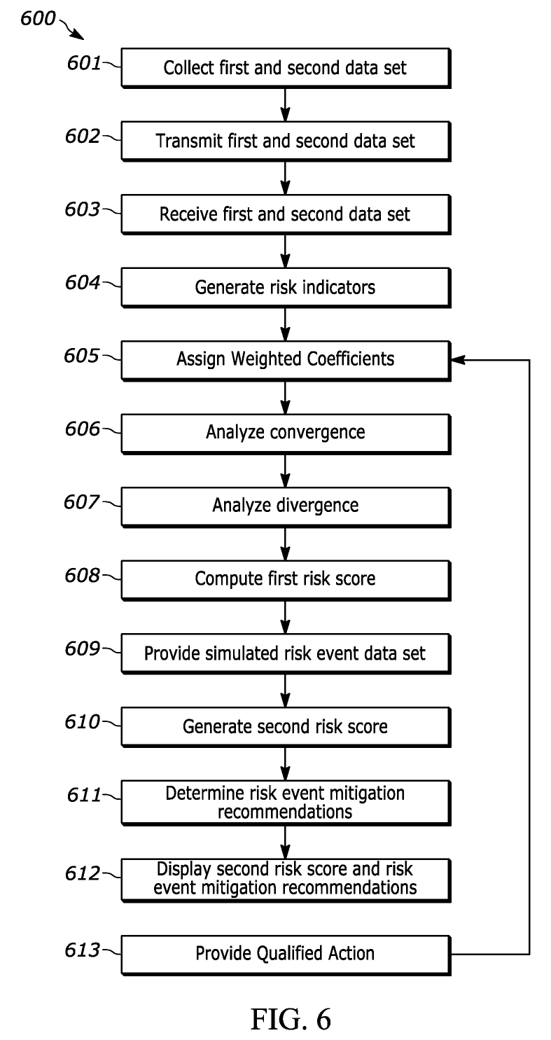

The detailed functioning of the system 100 for predicting and mitigating the risk event will now be described herein by way of a flowchart 600 (shown in FIG. 6) in view of FIG. 5. At operation 601, each data acquisition device 101 of the plurality of data acquisition devices 101 collects the first data set 501 (shown in FIG.5) and the second data set 502 (shown in FIG. 5) associated with the geographical location. As discussed above, the data acquisition devices 101 are installed at the geographical location to collect the first data set 501 and the second data set 502 associated with the geographical location. Additionally, or alternatively, in some embodiments, the data acquisition devices 101 collects or obtains the first data set 501 and/or the second data set 502 from the data sources 105 (shown in FIG. 1). At operation 602, the data acquisition devices 101 transmit the first data set 501 and the second data set 502 associated with the geographical location to the risk event mitigation server device 102 using the network interface 104.

At operation 603, the dynamic threat mitigation module 301 executed by the risk event mitigation server processor 202 receives the first data set 501 and generates a plurality of risk indicators 503 from the first data set 501, at operation 604. The term “risk indicators” as used herein refers to measurable parameters or variables derived from the first data set 501 that collectively represent the underlying conditions contributing to the likelihood of occurrence of the risk event at the geographical location. The plurality of risk indicators 503 for the geographic location includes one or more indicators from a group comprising a socioeconomic indicator (SES), a political instability indicator (PI), an ideological extremism indicator (IE), a social disenfranchisement indicator (SD), a lack of education indicator (LE), a psychological factor indicator (PSF), an external influence indicator (EI) associated with the geographic location, or other indicators now known or developed in the future. The socioeconomic indicator (SES) represents the economic and social well-being of the population and is determined by analyzing variables such as employment rate, income disparity, and access to essential services. The political instability indicator (PI) reflects governance continuity and public confidence, determined by assessing political turnover, civil unrest, and government policy fluctuations. The ideological extremism indicator (IE) represents the spread or presence of radical ideologies, measured using intelligence reports, communication trends, and historical records of extremist activities. The social disenfranchisement indicator (SD) quantifies marginalization or exclusion among population groups, derived from socioeconomic and demographic data including access to resources, representation, and social equity indices. The lack of education indicator (LE) reflects the overall educational attainment and literacy levels within the region, determined from educational data such as enrollment rates, literacy statistics, and dropout ratios. The psychological factor indicator (PSF) represents the collective emotional and behavioral state of the population, determined by analyzing sentiment data, survey responses, and psychological trend indicators. The external influence indicator (EI) reflects the degree of foreign or cross-border impact on regional stability, determined using intelligence data sets tracking foreign media activity, economic interference, and diplomatic events.

In one embodiment, upon receiving the first data set 501, the dynamic threat mitigation module 301 is configured to preprocess, analyze, and classify the first data set 501 and the second data set 502 into a plurality of indicator categories, each corresponding to a specific domain of societal and environmental stability. The classification process involves parsing and organizing heterogeneous data such as economic, political, demographic, educational, psychological, and intelligence data into structured feature groups based on their source attributes and contextual relevance. For example, data related to income levels, employment rates, and access to basic services is automatically categorized under the socioeconomic indicator (SES); data relating to political events, government turnover, protest frequency, and corruption metrics is categorized under the political instability indicator (PI); and data derived from intelligence feeds, communication logs, or social media content exhibiting ideological patterns is categorized under the ideological extremism indicator (IE). Similarly, demographic and welfare data reflecting inequality or exclusion is classified under the social disenfranchisement indicator (SD); educational performance metrics such as literacy rates and enrollment ratios are classified under the lack of education indicator (LE); emotional or sentiment-based data from surveys and communication records is classified under the psychological factor indicator (PSF); and geopolitical or intelligence data reflecting cross-border influence or foreign interference is categorized under the external influence indicator (EI). The dynamic threat mitigation module 301 employs predefined rule-based filters, metadata tagging, and machine learning-based feature extraction techniques to perform this classification automatically, ensuring that each incoming data stream is assigned to the appropriate indicator category for subsequent risk computation.

At operation 605, the dynamic threat mitigation module 301 executed by the risk event mitigation server processor 202 further assigns a plurality of weighted coefficients 504 to the plurality of risk indicators 503. Each coefficient 504 corresponds to the relative importance, sensitivity, or contribution of the associated indicator to the first data set 501. The assignment is configured to be performed without limitation using preconfigured values, historical trend analysis, rule-based heuristics, or adaptive machine learning algorithms. The plurality of weighted coefficients 504 are configured to be repressed as α(SES), β(PI), γ(IE), δ(SD), ε(LE), ζ(PSF), η(EI), where α, β, γ, δ, ε, ζ, and η represent the plurality of weighted coefficients 504 of the corresponding plurality of risk indicators 503. The dynamic threat mitigation module 301 is further configured to include a risk indicator correlation module (not shown) configured to identify and quantify interdependencies/interactions between the plurality of risk indicators 503, such that the first risk score 505 reflects both direct and indirect interactions among the risk indicators 503. For example, in the predefined assignment approach, the coefficients 504 are established in advance using expert knowledge, empirical studies, and domain-specific threat modeling. Each coefficient 504 is stored in a configuration database and represents the relative influence of the corresponding risk indicator 503 on the likelihood of a risk event. For example, in regions historically affected by economic distress and poor governance, the coefficients α(SES) and β(PI) are predefined as 0.30 and 0.25, respectively, to reflect their dominant contribution to overall instability. Conversely, indicators such as ideological extremism (IE) or psychological stress (PSF) are assigned lower predefined values, such as 0.10 or 0.07, representing secondary yet contributory effects. These coefficients are applied directly when calculating the first risk score 505, providing a stable and interpretable baseline for analysis. In another example, in the historical correlation–based assignment approach, the coefficients 504 are derived from statistical correlation between historical event outcomes and the corresponding risk indicators 503 extracted from the first data set 501. The dynamic threat mitigation module 301 applies regression and correlation analysis to quantify the strength of association between each indicator 503 and past risk occurrences. For instance, when historical analysis of civil unrest data shows that fluctuations in the political instability indicator (PI) and ideological extremism indicator (IE) exhibit correlation coefficients of 0.82 and 0.76 with event frequency, while socioeconomic conditions (SES) exhibit a correlation coefficient of 0.55, the dynamic threat mitigation module 301 assigns proportionally higher weights to β(PI) and γ(IE), such as 0.28 and 0.25, and a relatively lower weight to α(SES), such as 0.18. These empirically derived coefficients 504 are stored and periodically recalibrated as new historical data becomes available, ensuring that the coefficient distribution evolves in alignment with observed real-world event patterns. It should be appreciated that the specific coefficient values and numeric examples provided herein are merely illustrative and are not intended to limit the scope of the present disclosure. The actual coefficient values, relationships, and computational parameters vary depending on the geographic region, available data sets, or system configuration, and are adjusted automatically or manually within the operating range of the dynamic threat mitigation module 301.

At the operation 606, the dynamic threat mitigation module 301 executed by the risk event mitigation server device 102 further performs convergence analysis of the plurality of risk indicators 503. During convergence analysis, the dynamic threat mitigation module 301 identifies correlated or mutually reinforcing risk indicators 503 that exhibit similar directional trends or behavioral dependencies across spatial or temporal dimensions. The process is configured to employ statistical correlation, clustering, pattern recognition, or graph-based dependency mapping techniques to assess whether multiple indicators collectively signify a strengthening or compounding risk condition. For example, when the socioeconomic indicator (SES) shows a decline in employment rate while the political instability indicator (PI) simultaneously exhibits a rise in protest activity or policy volatility within the same geographic boundary, the convergence analysis classifies these indicators 503 as correlated and mutually reinforcing. Similarly, when the ideological extremism indicator (IE) and the psychological factor indicator (PSF) increase concurrently—detected through elevated online sentiment polarity and extremist content frequency— the convergence analysis identifies this pattern as a convergent behavioral cluster. The convergence analysis enables the dynamic threat mitigation module 301 to proportionally increase the associated weighted coefficients 504 of the correlated indicators 503, thereby amplifying their influence on the computed first risk score 505. This ensures that when multiple risk indicators 503 align in magnitude or trend, the overall model sensitivity accurately reflects the cumulative risk amplification rather than treating each indicator as independent or isolate

At operation 607, the dynamic threat mitigation module 301 executed by the risk event mitigation server device 102 further performs divergence analysis of the plurality of risk indicators 503. The divergence analysis is configured to identify indicators 503 that deviate from expected patterns or established baselines, including statistical outliers or contradictory behaviors relative to other correlated indicators 503. The process employs analytical techniques such as anomaly detection, residual modeling, outlier scoring, and temporal deviation mapping to distinguish abnormal or inconsistent data behaviors that distorts the overall risk assessment. For example, when the socioeconomic indicator (SES) and political instability indicator (PI) both exhibit an upward trend suggesting economic decline and governance stress, but the ideological extremism indicator (IE) unexpectedly remains low despite historical correlation with such conditions, the divergence analysis flags the IE value as a potential anomaly. Similarly, when the psychological factor indicator (PSF) shows an abrupt spike in public anxiety levels without corresponding changes in social disenfranchisement (SD) or real-time news data, the dynamic threat mitigation module 301 treats it as a divergent event likely caused by transient or non-representative factors. The divergence analysis enables the dynamic threat mitigation module 301 to dynamically adjust or down-weight the influence of outlier indicators 503 by modifying their corresponding weighted coefficients 504. This ensures that the computation of the first risk score 505 remains resilient to noise, sensor anomalies, and false positives, maintaining both statistical integrity and contextual accuracy. The integration of convergence and divergence analyses thereby ensures that the system 100 remains adaptively balanced by amplifying correlated signals while suppressing inconsistent or misleading deviations in the data.

At operation 608, the dynamic threat mitigation module 301 computes a first risk score 505. The first risk score 505 reflects the plurality of weighted coefficients 504 to the plurality of risk indicators 503 and their convergent and divergent interactions. The first risk score 505 forecasts a likelihood of occurrence of the risk event at the geographical location based on the weighted risk indicators 503, in consideration with dynamic adjustment to the plurality of the weighted coefficients 504 by the convergence and divergence analyses. The first risk score (T1), which configured to be expressed as: T1=α(SES)+ β(PI)+ γ(IE)+ δ(SD)+ ε(LE)+ ζ(PSF)+ η(EI), where α, β, γ, δ, ε, ζ, and η represent the plurality of weighted coefficients 504 for the corresponding the plurality of risk indicators 503.

At operation 609, the continuous automated red teaming module 302 executed by the risk event mitigation server device 102 receives the first data set 501 and the second data set 502 to simulate a risk event 506 to provide a simulated risk event data set 508. As discussed above, the first data set 501 includes one or more data sets from the group comprising the historical data set, the socioeconomic data set, the educational data set, and the intelligence data set associated with the geographical location. The second data set 502 includes one or more data sets from the group comprising the real-time intelligence data set, the real-time news data set, the real-time political data set, and the real-time social media data set associated with the geographical location. The continuous automated red teaming module 302 includes one or more artificial intelligence (AI) based models 302a to generate the simulated risk event data set 508. The one or more AI based models 302a include but not limited to generative models, reinforcement learning agents, adversarial learning networks, and generative adversarial networks (GANs) for creating synthetic data that statistically resembles real-world event patterns; reinforcement learning (RL) frameworks for exploring adversarial strategies or cascading system failures; Bayesian probabilistic models for capturing uncertainty and event likelihood; and recurrent neural networks (RNNs) or transformer-based models for temporal or sequential event forecasting configured to operate individually or cooperatively to ensure both realism and variability in the generated scenarios.

The one or more AI based models 302a employ supervised and unsupervised learning paradigms to learn multi-dimensional relationships among the plurality of risk indicators 503. For example, a generative adversarial network (GAN) is trained using labeled instances of prior risk events such as social unrest, border conflicts, or cyberattacks where the generator network learns to produce synthetic feature patterns that resemble real-world event progressions, and the discriminator network learns to distinguish between authentic and simulated data. In parallel, reinforcement learning (RL) agents are trained using policy-gradient or Q-learning algorithms to explore and optimize sequences of adversarial actions or environmental triggers that historically led to risk events. Once trained, the continuous automated red teaming module 302 executes a multi-stage simulation process. The continuous automated red teaming module 302 ingests the latest combined data from the first data set 501 and the second data set 502, processes these through the trained generative models, and produces a range of plausible event trajectories. Each trajectory comprises structured and unstructured data points such as predicted indicator variations, projected temporal sequences, and probabilistic event triggers collectively forming the simulated risk event data set 508. The simulated risk event data set 508 represents a set of artificially generated statistically consistent scenarios that emulate how real-world risk events unfold under current or hypothetical conditions. For instance, when the input data reflects rising unemployment (SES) and increasing political protests (PI), the continuous automated red teaming module 302 generates a simulated event sequence forecasting civil unrest, including estimated onset time, duration, and impact radius. Similarly, when social media sentiment (PSF) and external influence activity (EI) show high divergence, the simulation predicts the potential for a coordinated disinformation campaign. The generated simulated risk event data set 508 is then transmitted to the machine learning adaptation module 303, where it is utilized in conjunction with real-time data to refine and validate predictive models. This ensures that the system 100 continuously evaluates both actual and hypothetical event pathways, maintaining readiness against emergent and previously unobserved risk scenarios.

At operation 610, the machine learning adaptation module 303 executed by the risk event mitigation server device 102 refines the first risk score 505 with the second data set 502 and the simulated risk event data set 508 to generate a second risk score 509. In accordance with various embodiments, the second risk score 509 is updated in real-time based on the second data set 502 and the simulated risk event data set 508 to predict the risk event. The machine learning adaptation module 303 is configured to include, without limitation, one or more supervised, unsupervised, or semi-supervised learning models, wherein the supervised models are configured to include, without limitation, a linear and nonlinear regression model, a gradient boosting ensemble model, a support vector machine (SVMs), a feed-forward model, a convolutional neural network (CNNs) trained model. Unsupervised models are configured to include, without limitation, a clustering algorithm model, a self-organizing maps model, and autoencoders configured to detect novel patterns or previously unseen correlations within the incoming data. For example, assume the first risk score 505 indicates a moderate threat level for a given geographical region based on static socioeconomic and political indicators. Subsequently, the second data set 502 detects a sudden surge in social media discussions with negative sentiment related to government actions, while the simulated risk event data set 508 predicts a pattern similar to previous incidents of mass protest escalation. The machine learning adaptation module 303 integrates these new data points and recalculates the overall probability of risk occurrence, thereby increasing the second risk score 509 to a higher level. Conversely, when the real-time data shows stabilization in political discussions or a reduction in extremist online activity, the machine learning adaptation module 303 proportionally reduces the risk score 509. The first risk score 505 and the second risk score 509 are configured to forecast the likelihood of occurrence of the risk event at the geographical location. For example, when the first risk score 505 initially forecasts a forty five percent (45%) likelihood of civil unrest in a metropolitan region based on historical socioeconomic decline and political instability indicators, the second risk score 509 forecasts an increased likelihood of seventy two percent (72%), reflecting newly detected real-time indicators such as escalating online dissent, protest-related keywords in social media feeds, and simulated event trajectories predicting potential crowd mobilization, after refinement through the machine learning adaptation module 303. Conversely, when subsequent real-time inputs indicate de-escalation such as improved sentiment trends or intervention by local authorities, the second risk score 509 dynamically adjusts downward, providing a continuously updated and data-driven forecast of the evolving risk environment.

At operation 611, the orchestrator module 304 executed by the risk event mitigation server device 102 communicates between and combines the output of the dynamic threat mitigation module 301, the continuous automated red teaming module 302, and the machine learning adaptation engine 303 to determine a set of risk event mitigation recommendations 510 for the geographical location. The set of risk event mitigation recommendations 510 are determined using a predefined risk-action mapping framework stored within the orchestrator module 304. This framework correlates specific ranges of the second risk score 509 with one or more dominant risk indicators 503 to identify corresponding mitigation actions appropriate to the predicted threat profile. Each mapping entry defines the severity threshold, contributing indicator(s), and corresponding recommended responses. For example, when the second risk score 509 exceeds a predefined “high-risk” threshold (for instance, above 0.75 on a normalized scale) and the dominant contributing indicators are political instability (PI) and social disenfranchisement (SD), the orchestrator module 304 automatically retrieves and generates predefined recommendations, such as, activating local law enforcement coordination protocols, initiating public communication strategies, or enabling rapid resource mobilization for affected districts. In another example, when the second risk score 509 is moderate (for instance, between 0.5 and 0.7) and the dominant indicators include ideological extremism (IE) and external influence (EI), the orchestrator module 304 issues predefined recommendations such as increasing digital monitoring intensity, verifying online information sources, or restricting external communication channels to limit disinformation propagation.

The orchestrator module 304 functions as an integration and coordination layer that manages data flow and operational sequencing among the output of the dynamic threat mitigation module 301, the continuous automated red teaming module 302, and the machine learning adaptation module 303, ensuring that the refined outputs of the machine learning adaptation module 303, the continuous automated red teaming module 302, and the dynamic threat mitigation module 301 are transmitted coherently and in real time to the user device 103. The orchestrator module 304 further includes a workflow management module (not shown) for sequencing operational processes, a data integration layer for normalizing and validating inter-module data, and an event bus or messaging system to enable asynchronous communication and real-time event propagation. The risk event mitigation recommendations 510 are configured to include prioritized response actions, strategic advisories, or system-level configurations derived from analysis of the second risk score 509. The recommendations 510 are configured to be generated using contextual parameters such as geographic region, asset class, resource availability, or threat type, and are configured to include both automated and manual response options. For example, when the second risk score 509 for a geographical region is calculated as 0.35, which falls within the low-risk range, and the dominant indicators include socioeconomic stability (SES) and education level (LE), the orchestrator module 304 retrieves a predefined recommendation set that includes maintaining routine monitoring, updating local data feeds once every 24 hours, and ensuring continued observation of social and political trends. In another example, when the second risk score 509 increases to 0.68, categorized as moderate risk, and the dominant indicators are political instability (PI) and psychological factor (PSF), the orchestrator module 304 selects recommendations such as issuing preliminary alerts to regional authorities, activating enhanced sentiment and news analytics, and preparing rapid response personnel for potential escalation. In a further example, when the second risk score 509 reaches a high-risk threshold, such as 0.82, with dominant indicators of social disenfranchisement (SD) and ideological extremism (IE), the orchestrator module 304 retrieves predefined mitigation recommendations such as deploying emergency communication networks, initiating local crowd monitoring protocols, and coordinating with law enforcement or cybersecurity agencies to prevent event escalation. Finally, when the second risk score 509 exceeds a critical threshold (for example, above 0.9) with strong external influence (EI) or cross-border interference indicators, the orchestrator module 304 retrieves national-level response protocols including, but not limited to activating crisis command centers, implementing controlled information dissemination strategies, or enabling cross-agency intelligence collaboration.

The orchestrator module 304 then communicates the second risk score 509 and the set of risk event mitigation recommendations 510 for the geographical location to the user device 103. In accordance with various embodiments, the post-quantum encryption service module 305 is configured to provide the quantum-resistant encryption framework to secure the communication between the dynamic threat mitigation module 301, the machine learning adaptation module 303, and the continuous automated red teaming module 302.

Upon receiving the second risk score 509 and the associated recommendations 510, the user device 103, at operation 612, displays the information via the user device graphical user interface 406, a dashboard, or an alerting system configured to support user review and interaction. The user device 103 receives the complete data package transmitted by the orchestrator module 304, which includes (i) the numerical value of the second risk score 509, (ii) the corresponding risk category (for example, low, moderate, high, or critical), (iii) the dominant contributing risk indicators 503 with their respective weighted coefficients 504, and (iv) the associated predefined mitigation recommendations 510 retrieved from the mapping framework. In some embodiments, the data package also includes supporting contextual information, such as a breakdown of contributing data sources, geographic heat maps, real-time trend graphs, or simulated event projections derived from the continuous automated red teaming module 302. For example, when the user device 103 receives a high-risk alert for a particular city with a second risk score 509 of 0.82, the user device graphical user interface 406 displays a visual summary showing: (a) the score level with a color-coded severity indicator (for instance, red for high risk), (b) a list of top contributing factors such as “increased protest activity” or “negative social sentiment,” and (c) the predefined recommended actions such as “deploy surveillance assets,” “initiate emergency coordination,” or “issue public advisory.” The user device graphical user interface 406 also provides interactive controls that allow the user to drill down into each indicator 503 to view source-level details, historical comparisons, or confidence levels of the assessment.

The user device 103 further requests a qualified action 512 from the user via a recursive feedback loop to be configured to continuously adjust the plurality of weighted coefficients 504 of the plurality of risk indicators 503 to continuously update the second risk score 509 and the risk event mitigation recommendations 510 in real-time for the geographical location. The qualified action 512 includes approving, rejecting, modifying, or prioritizing a specific mitigation recommendation and/or providing feedback related to real-time intelligence, real-time news, real-time political, or real-time social media feedback corresponding to the geographical location. At 613, the user device 103 provides the qualified action 512 back to the risk event mitigation server device 102. The risk event mitigation server device 102 incorporates the qualified action into a recursive feedback loop that continuously enhances the adaptive learning and modeling process. The user may be an authorized expert, such as a security analyst, policy strategist, emergency response officer, or intelligence operator, possessing domain-specific knowledge that allows for contextual interpretation of outputs of the risk event mitigation server device 102. For example, when the risk event mitigation server device 102 generates a high-risk score of 0.82 for a city based on social disenfranchisement (SD) and political instability (PI), the qualified action 512 includes approving deployment of surveillance resources but rejecting a recommendation for large-scale mobilization after confirming that the situation remains contained. In another case, when a moderate risk is detected based on elevated online sentiment, but local intelligence confirms that the data spike is unrelated to instability, the qualified action 512 includes marking the event as a false alarm. This input is transmitted as the qualified action 512 indicating data misclassification. In some embodiments, the qualified action 512 is recommended and provided by the risk event mitigation server device 102 to the user device 103 for approval or rejection.

The recursive feedback loop enables the system 100 to refine its internal models using human-in-the-loop feedback, aligning algorithmic recommendations with expert or operational judgment while maintaining adaptive autonomy. As the recursive feedback loop updates the plurality of weighted coefficients 504 of the plurality of risk indicators 503, the second risk score 509, and corresponding risk event mitigation recommendations 510 are recalculated in real time. In such cases, the dynamic threat mitigation module 301 continuously updates the weighted coefficients 504 of the plurality of risk indicators 503 based on user feedback (for example, the qualified action 512) and the second data set 502, to provide the second risk score 509 and the risk event mitigation recommendations 510 in real-time. This ensures that the system 100 reflects the most current conditions and user insights for the geographical location. The orchestrator module 304 continuously synchronizes these updates across interconnected components, ensuring that the displayed outputs on the user device 103 accurately represent the updates for the second risk score 509 for the geographical location. In certain embodiments, the orchestrator module 304 is configured to utilize a secure communication channel and a cryptographic signing mechanism (e.g., managed by the post-quantum encryption service module 305) to authenticate the qualified action feedback and protect data integrity during transmission. The integration of the orchestrator module 304, the user device 103, and the recursive feedback mechanism enables a closed-loop adaptive intelligence framework, in which machine learning predictions, human insights, and real-time data collectively contribute to the continuous optimization of the risk event prediction process, thereby enhancing the accuracy, transparency, and responsiveness of the risk event prediction and mitigation system 100. The post-quantum encryption service module 305 implements deterministic, quantum-resistant key management, including a policy-to-envelope mapping, a dynamic key rotation, and an enforcement mechanism to prevent access to encryption keys by machine-learning inference processes.

In the foregoing specification, specific embodiments have been described. However, one of ordinary skill in the art appreciates that various modifications and changes are configured to be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Moreover, an embodiment is configured to be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. A system for predicting and mitigating a risk event, the system comprising:
a plurality of data acquisition devices configured to collect a first data set and a second data set associated with a geographical location;
a network interface communicatively coupling the plurality of data acquisition devices and configured to transmit the first data set and the second data set;
a risk event mitigation server device comprising:
one or more risk event mitigation server processors in communication with the network interface, and one or more risk event mitigation sever memories storing instructions that, when executed by the one or more risk event mitigation processors, cause the risk event mitigation server device to execute;
a dynamic threat mitigation module to:
receive the first data set from the network interface;
generate the plurality of risk indicators from the first data set;
assign a plurality of weighted coefficients to the plurality of risk indicators;
analyze a convergence of the plurality of risk indicators;
analyze a divergence of the plurality of risk indicators; and
compute a first risk score, wherein the first risk score incorporates the plurality of weighted coefficients to the plurality of risk indicators and their convergent and divergent interactions;
a continuous automated red teaming module configured to employ an artificial-intelligence model to simulate a risk event using the first data set and the second data set, and provide a simulated risk event data set;
a machine learning adaptation module configured to refine the first risk score using the second data set and the simulated risk event data set to generate a second risk score;
an orchestrator module configured to control communication between and combine the output of the dynamic threat mitigation module, the continuous automated red teaming module, and the machine learning adaptation module to determine a set of risk event mitigation recommendations for the geographical location; and
a post-quantum encryption service module configured to provide a quantum-resistant encryption framework to secure the communication between the dynamic threat mitigation module, the machine learning adaptation module, and the continuous automated red teaming module; and
a user device communicatively coupled to the risk event mitigation server device via the network interface and configured to display, via a user device display, the second risk score and the set of risk event mitigation recommendations for the geographical location, and provide a qualified action,
wherein the risk event mitigation server device further implements a recursive feedback loop configured to continuously adjust the plurality of weighted coefficients of the plurality of risk indicators in the dynamic threat mitigation module based on the qualified action and the second data set, continuously updating the second risk score and the risk event mitigation recommendations in real-time.

2. The system of claim 1, wherein the first risk score and the second risk score are configured to forecast a likelihood of occurrence of the risk event at the geographical location, and wherein the second risk score is updated in real-time based on the second data set and the simulated risk event data set generated by the continuous automated red teaming module to predict the risk event.

3. The system of claim 1, wherein the continuous automated red teaming module employs one or more artificial-intelligence models, comprises one or more from a group comprising generative models, reinforcement learning agents, and adversarial learning networks to generate the simulated risk event data set.

4. The system of claim 1, wherein the post-quantum encryption service module implements deterministic, quantum-resistant key management, including a policy-to-envelope mapping, a dynamic key rotation, and an enforcement mechanism to prevent access to encryption keys by machine-learning inference processes.

5. The system of claim 1, wherein the qualified action includes providing feedback related to real-time intelligence, real-time news, real-time political, or real-time social media feedback corresponding to the geographical location.

6. The system of claim 1, wherein the dynamic threat mitigation module continuously updates the weighted coefficients of the plurality of risk indicators based on user feedback and the second data set, to provide the second risk score and the risk event mitigation recommendations in real-time.

7. The system of claim 1, wherein the plurality of data acquisition devices comprises one or more from a group comprising a surveillance camera, an acoustic sensor, a motion detector, an environmental sensor, and a Global Positioning System enabled mobile device.

8. The system of claim 1, wherein the plurality of risk indicators for the geographic location includes one or more indicators from a group comprising a socioeconomic indicator, a political instability indicator, an ideological extremism indicator, a social disenfranchisement indicator, a lack of education indicator, a psychological factor indicator, and an external influence indicator associated with the geographical location.

9. The system of claim 1, wherein the first data set includes one or more data sets from a group comprising a historical data set, a socioeconomic data set, an educational data set, and an intelligence data set associated with the geographical location.

10. The system of claim 1, wherein the second data set includes one or more data sets from a group comprising a real-time intelligence data set, a real-time news data set, a real-time political data set, and a real-time social media data set associated with the geographical location.

11. A method for predicting and mitigating a risk event at a geographical location, the method comprising:
collecting a first data set and a second data set associated with the geographical location using a plurality of data acquisition devices;
transmitting the first data set and the second data set to a risk event mitigation server device via a network interface;
receiving, by a dynamic threat mitigation module of the risk event mitigation server device, the first data set;
generating, by the dynamic threat mitigation module, the plurality of risk indicators from the first data set;
assigning, by the dynamic threat mitigation module, a plurality of weighted coefficients to the plurality of risk indicators;
analyzing, by the dynamic threat mitigation module, a convergence of the plurality of risk indicators;
analyzing, by the dynamic threat mitigation module, a divergence of the plurality of risk indicators;
computing, by the dynamic threat mitigation module, a first risk score, wherein the first risk score incorporates the plurality of weighted coefficients to the plurality of risk indicators and their convergent and divergent interactions;
simulating, by a continuous automated red teaming module of the risk event mitigation server device, a risk event using the first data set and the second data set to provide a simulated risk event data set;
refining, by a machine learning adaptation engine of the risk event mitigation server device, the first risk score using the second data set and the simulated risk event data set to generate a second risk score;
controlling, by an orchestrator module of the risk event mitigation server device, communication between and combining the output of the dynamic threat mitigation module, the continuous automated red teaming module, and the machine learning adaptation engine to determine a set of risk event mitigation recommendations for the geographical location;
displaying, via a user device, the second risk score and the set of risk event mitigation recommendations for the geographical location;
providing, via the user device, a qualified action;
implementing, by the risk event mitigation server device, a recursive feedback loop to continuously adjust the plurality of weighted coefficients of the plurality of risk indicators in the dynamic threat mitigation module based on the qualified action and the second data set; and
continuously updating the second risk score and the risk event mitigation recommendations in real-time.

12. The method of claim 11, wherein the first risk score and the second risk score are configured to forecast a likelihood of occurrence of the risk event at the geographical location, and wherein the method further comprises:
updating the second risk score in real-time based on the second data set and the simulated risk event data set generated by the continuous automated red teaming module to predict the risk event.

13. The method of claim 11, wherein the implementation of the recursive feedback loop continuously updates the second risk score and the risk event mitigation recommendations in real-time.

14. The method of claim 11, wherein the first risk score reflects both direct and indirect interactions among the plurality of risk indicators, wherein the method further comprises:
identifying and quantifying interactions between the plurality of risk indicators using a risk indicator correlation module within the dynamic threat mitigation module.

15. The method of claim 11, further comprising:
employing one or more artificial-intelligence models selected from the group consisting of generative models, reinforcement learning agents, and adversarial learning networks within the continuous automated red teaming module to generate the simulated risk event data set.

16. The method of claim 11, further comprising securing communication between the dynamic threat mitigation module, the machine learning adaptation module, and the continuous automated red teaming module using a post-quantum encryption service module implementing deterministic quantum-resistant key management.

17. The method of claim 11, the first data set includes one or more data sets from a group comprising a historical data set, a socioeconomic data set, an educational data set, and an intelligence data set associated with the geographical location.

18. The method of claim 11, wherein the second data set includes one or more data sets from a group comprising a real-time intelligence data set, a real-time news data set, a real-time political data set, and a real-time social media data set associated with the geographical location.

19. The method of claim 11, wherein the plurality of risk indicators for the geographic location includes one or more indicators from a group comprising a socioeconomic indicator, a political instability indicator, an ideological extremism indicator, a social disenfranchisement indicator, a lack of education indicator, a psychological factor indicator, and an external influence indicator associated with the geographical location.
